(19) United States
(12) Patent Application Publication
(10) Pub. No.: US 2026/0288246 A1
(43) Pub. Date: Sep. 24, 2026

(54) SPATIAL MOUSE FOR SMART HOME AND OBJECT INTERACTIONS

(71) Applicant: Meta Platforms Technologies, LLC, Menlo Park, CA (US)

(72) Inventors: Kerkil Choi, Los Gatos, CA (US); Honghong Peng, Los Altos, CA (US); Shuochen Su, Bellevue, WA (US); Victor Knai, Emeryville, CA (US)

(21) Appl. No.: 19/087,282

(22) Filed: Mar. 21, 2025

(51) Int. Cl. G06F 3/01; G06V 20/20

(52) U.S. Cl. CPC G06F 3/017; G06V 20/20

(57) ABSTRACT

A system of the subject technology includes an apparatus including a number of sensors to detect one or more objects pointed to by a spatial mouse. The system further includes a processor to process data from the plurality of sensors, recognize the objects based on the processed data and execute a command based on the recognized objects.

### TECHNICAL FIELD

The present disclosure generally relates to smart home devices, and more particularly, to a spatial mouse for smart home and object interactions.

### BACKGROUND

Smart homes have revolutionized the way we interact with our living environments, integrating advanced technologies to automate and control various household functions. These systems encompass a wide range of devices, including lighting, heating, security, and entertainment systems, all interconnected through a central network. The primary goal of smart homes is to enhance convenience, efficiency, and security for users by allowing seamless control over these devices. However, the effectiveness of smart home systems heavily relies on the user interface and input methods employed to interact with these devices. Traditional pointing devices, such as mice and touchpads, have been the standard for interacting with digital interfaces, but they present several limitations when applied to smart home environments.

Traditional pointing devices are primarily designed for two-dimensional interactions on flat surfaces, which can be restrictive in the context of smart homes. These devices often lack the precision and intuitiveness required for controlling a diverse array of smart home devices that may be distributed throughout a living space. For instance, using a mouse or touchpad to adjust lighting or thermostat settings can be cumbersome and unintuitive, especially when users need to navigate through multiple menus or interfaces. Additionally, traditional pointing devices do not support natural gestures or three-dimensional movements, limiting their ability to provide a seamless and immersive user experience. These limitations highlight the need for more advanced input methods that can offer greater flexibility, precision, and ease of use in smart home environments.

### SUMMARY

According to some aspects, an apparatus of the subject technology includes an apparatus including a number of sensors to detect one or more objects pointed to by a spatial mouse. The system further includes a processor to process data from the plurality of sensors, recognize the objects based on the processed data and execute a command based on the recognized objects.

According to other aspects, a method of the subject technology includes detecting a target object pointed to by a user based on data captured by a number of sensors, and displaying a pointer laid over the detected target object on a display of a head-mount device (HMD) to confirm, by the user, that a spatial mouse pointer is on a right object. The method further includes recognizing and localizing the target object, and sending a command based on the detected recognized and localized target object.

According to yet other aspects, a method of the subject technology includes receiving sensor data from several sensors, and detecting and recognizing an object pointed to by a spatial mouse represented by a first hand of a user based on the sensor data. The method further includes recognizing one or more gestures by a second hand of the user based on the sensor data and the detected object, and sending a command based on the detected, recognized object and the recognized one or more gestures.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram illustrating an example of a head-mount device (HMD) for MR applications within which some aspects of the subject technology are implemented.

FIG. 2 is a state diagram illustrating an example of a spatial mouse application for a hand gesture for an action, according to some aspects of the subject technology.

FIG. 3 is a state diagram illustrating an example of a spatial mouse application for a user hand to point to a physical object, according to some aspects of the subject technology.

FIG. 4 is a flow diagram illustrating an example of a method of object interaction using a spatial mouse, according to some aspects of the subject technology.

FIG. 5 is a flow diagram illustrating an example of a method of smart home integration using a spatial mouse, according to some aspects of the subject technology.

FIG. 6 is a flow diagram illustrating an example of a method of a hand gesture for various actions, according to some aspects of the subject technology.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

Some aspects of the subject disclosure are directed to a spatial mouse for smart home and object interactions. The spatial mouse of the subject technology integrates a user interface with a smart home system and is an apparatus for interacting with any object for use in head-mount devices (HMDs) such as mixed reality (MR) headsets and smart or augmented reality (AR) glasses. The subject solution is an extension of a user interface that mimics a computer mouse in three dimensions (3D) for MR headsets and smart glasses that enable users to interact with artificial intelligence (AI) more naturally and intuitively.

This disclosed solution proposes a method for displaying a ray that visualizes the direction the user points in and the precise location the user points at. The disclosed method can also highlight the object the user points at by segmenting the part and changing the color or other cues about the object. A mechanism such as a hand gesture could be used to play a role of button clicking in the case of a 2D mouse. When the selected object by clicking is a part of, for example, a light bulb of a smart home system, another hand motion or gesture could be used to operate the object. For instance, making a fist with the other hand could turn on or off the light bulb or a motion of drawing a circle or turning a knob could change the temperature of a smart thermostat.

A spatial mouse for smart home and object interactions represents a significant advancement in the realm of human-computer interaction, particularly within the context of smart home environments. This innovative device leverages spatial sensing technologies to enable users to interact with digital interfaces and physical objects in a more intuitive and natural manner. Unlike traditional input devices, the spatial mouse can detect and interpret three-dimensional movements and gestures, allowing for seamless control of various smart home devices such as lighting, thermostats, and entertainment systems. By integrating advanced sensors and machine learning algorithms, the spatial mouse can accurately track user movements and translate them into precise commands, enhancing the overall user experience and providing a more immersive interaction with smart home ecosystems.

The development of a spatial mouse for smart home and object interactions addresses several key challenges associated with current smart home technologies. Traditional control methods, such as touchscreens and voice commands, often lack the precision and intuitiveness required for complex interactions. The spatial mouse overcomes these limitations by offering a more direct and responsive means of control, reducing the cognitive load on users and enabling more efficient management of smart home devices. Additionally, the spatial mouse can facilitate interactions with AR and virtual reality (VR) applications, further expanding its utility beyond traditional smart home scenarios. This versatility makes the spatial mouse a valuable tool for enhancing user engagement and interaction within increasingly sophisticated digital and physical environments.

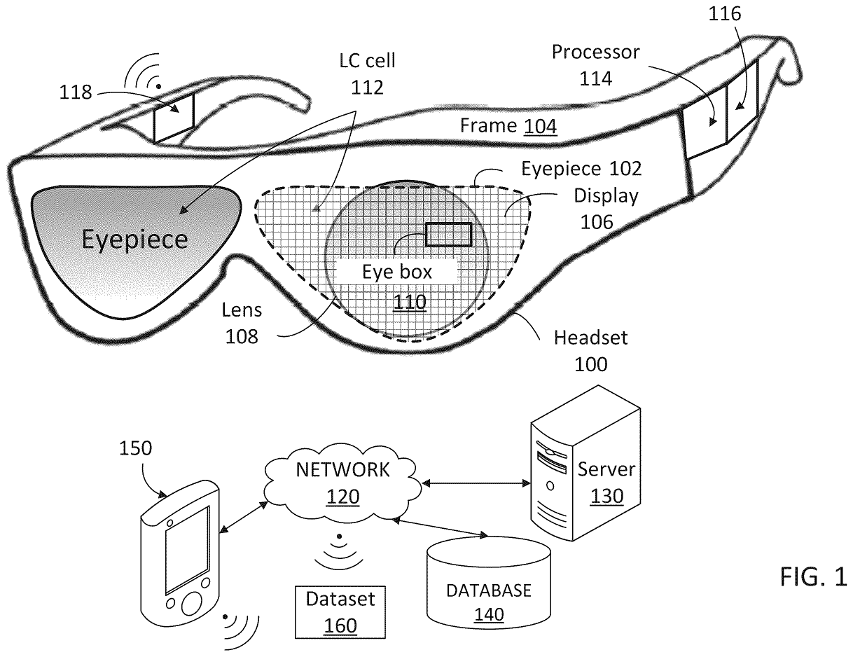

Turning now to the figures, FIG. 1 is a schematic diagram illustrating an example of an HMD 100 for MR applications within which some aspects of the subject technology are implemented. The eyepieces 102 are mounted on a frame 104 and provide a transmitted image from the real world to a headset user. In some embodiments, a display 106 may also be configured to provide a computer-generated image to the headset user (e.g., for MR applications). The lens 108 optically couples the display 106 to an eye box 110 delimiting an area where a user's pupil is located.

At least one of the eyepieces 102 or the lens 108 includes an LC cell 112, as disclosed herein. Accordingly, the LC cell 112 may include a liquid crystal layer sandwiched between polymer aligning layers and electrode layers (not shown here for simplicity). The electrode layers provide an electric field that aligns the LC molecules in the LC layer along the electric field. The polymer alignment layer provides a default alignment of the LC molecules in the LC layer, absent an electric field across the electrode layer. When the electrodes are activated, the polymer alignment layer is oxidized (anode) and reduced (cathode), thus losing its ability to attach with LC molecules of the LC layer, which become free to align with the electric field. An LC layer may be used in one or both eyepieces 102 as a transparency controller. For example, the user may desire a high transparency in an area of an eyepiece that provides a real-world throughput image. When a portion of the eyepiece is used to display a computer-generated image or icon, it is desirable that the background of the eyepiece be opaque. In one or more implementations, the lens 108 coupling the display 106 or eyepiece 102 to the eye box 110 may include a pancake lens or other type of lens. In some implementations, the HMD 100 includes a number of sensors and an IMU, not shown for simplicity.

The HMD 100 may include a processor circuit 114 and a memory circuit 116. The memory circuit 116 may store instructions which, when executed by processor circuit 114, cause the HMD 100 to provide the computer-generated image. In addition, the HMD 100 may include a communications module 118. The communications module 118 may include radio-frequency software and hardware configured to wirelessly communicate with the processor circuit 114 and the memory circuit 116, with a network 120, a remote server 130, a database 140, or a mobile device 150 handled by the user of the HMD 100. The HMD 100, mobile device 150, remote server 130, and database 140 may exchange commands, instructions, and data, via a dataset 160, through the network 120. Accordingly, the communications module 118 may include radio antennas, transceivers, and sensors, and also digital processing circuits for signal processing according to any one of multiple wireless protocols such as Wi-Fi, Bluetooth, Near field contact (NFC), and the like.

In addition, the communications module 118 may also communicate with other input tools and accessories cooperating with the HMD 100 (e.g., handle sticks, joysticks, mouse, wireless pointers, and the like). The network 120 may include, for example, any one or more of a local area network (LAN), a wide area network (WAN), the Internet, and the like. Further, the network 120 can include, but is not limited to, any one or more of the following network topologies, including a bus network, a star network, a ring network, a mesh network, a star-bus network, tree or hierarchical network, and the like.

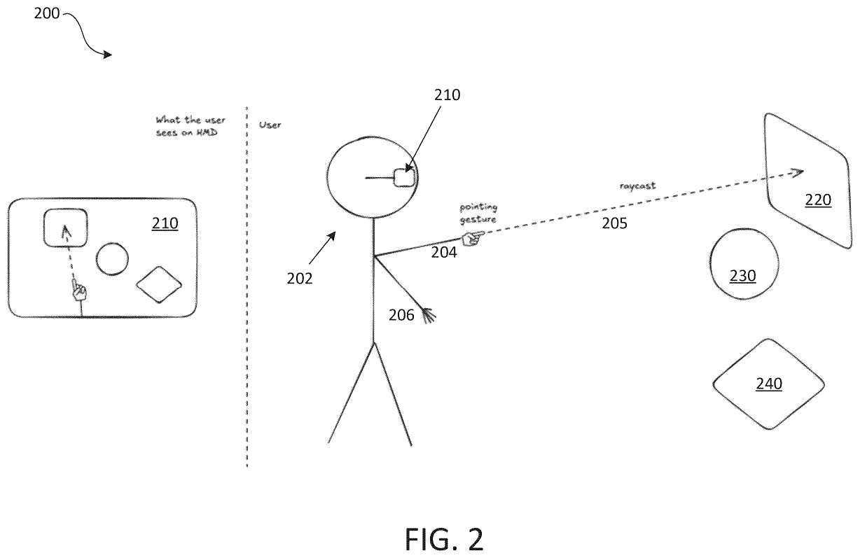

FIG. 2 is a state diagram illustrating an example of a spatial mouse application 200 for a hand gesture in an action, according to some aspects of the subject technology. In the spatial mouse application 200, the user 202 wearing an HMD (e.g., HMD 100 of FIG. 1) can see an image of a number of objects 220, 230 and 240 on a display 210 of an HMD. The user 202 can utilize one of their hands (e.g., 204) to point to a physical object such as the object 220 in their field of view, which they also see in the HMD. A dashed line 205 is a virtual line indicating the pointing direction, and the arrow on the end of dashed line 205 indicates the ray casted intersection against the object 220. In some aspects, the objects 220, 230 and 240 may represent a light bulb, a thermostat, a remote switch or other items in a smart home or an item in a shelf or a cabin fridge of a smart store.

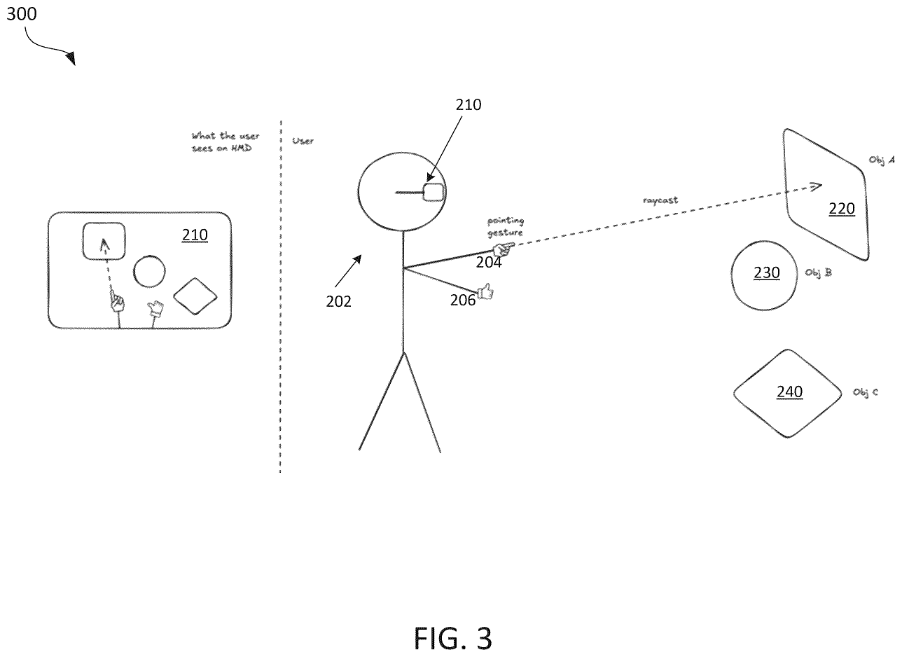

FIG. 3 is a state diagram illustrating an example of a spatial mouse application 300 for a user hand to point to a physical object, according to some aspects of the subject technology.

The environment of the spatial mouse application 300 is similar to that of the spatial mouse application 200 of FIG. 2, except that the user 202 uses their other hand 206 for a gesture. The user 202 while pointing to the object 220 with the hand 204 uses the other hand 206 with a specific gesture to trigger an event such as a thumbs up gesture mimicking a click event. The user 202 could confirm certain interaction with the pointed object 220, for example, in the case when the object 220 is a smart lamp, turn on or turn off the lamp. In some aspects, the objects 220, 230 and 240 may represent a light bulb, a thermostat, a remote switch or other items in a smart home or an item in a shelf or a cabin fridge of a smart store.

One of the design goals for a spatial mouse of the subject technology is to reduce user friction when onboarding the 3D interface from a traditional 2D computer-mouse interface. To this end, the spatial mouse mimics a traditional mouse in the sense that it can function, for example, as virtual cursors, buttons, scroll wheels, touch surfaces and multi selections, as described herein.

A cursor in the shape of an arrow icon, a disk, or any shape of choice is visualized at the location where the pointing ray intersects with the scene geometry, indicating the scene element (e.g., object 220) the user intends to interact with. The cursor icon can be optionally resized to indicate the distance the pointed scene element is away from the user. Additionally, the orientation of the cursor can be aligned with the surface normal of the pointed scene element, which may help provide visual cues to facilitate the interaction with 3D objects.

The virtual cursor offers noticeably improved specificity in terms of power to disambiguate the objects to interact by the user or the intent the user has for the interactions. For example, imagine that smart glasses are natively connected to the Bluetooth devices and have native apps for controlling such devices. When a user presses a button on a Bluetooth speaker to change the volume, this cursor will enable the user to precisely point to and select the button to do that. This would allow the user to avoid having to carry around the remote or pull up the remote-control app on her cell phone and reduces the friction due to the multiple steps involved in the control.

A virtual button may be visualized and attached to the user's hand, wrist, or arm, and the pressing event can be triggered by touching it using another hand, for example, or another dedicated hand gesture. For instance, dragging or a region-of-interest (ROI) selection can be achieved by pressing the button while adjusting the pointing direction. Accordingly, visualization can be made to highlight the effect of these inputs, for example, by highlighting the segmentation masks of the selected scene objects within the ROI.

A virtual scrolling wheel may be visualized and attached to the user's hand, wrist, or arm, and the scrolling event can be triggered by touching and rotating it using another hand, for example, or with a dedicated hand gesture, such as rotating the wrist while making a fist. Certain default use cases can be designed to get triggered by the scrolling event. For example, on the AR or MR displays, the imagery of the scene may be zoomed in around the cursor to effectively turn the device into a telescope, or to provide finer grained pointing control for small or faraway objects.

In a virtual touch surface application, an area of choice on the user's hand/wrist/arm may be allocated as the surface for any touch events. This mimics the functionality of a traditional computer trackpad, allowing single or multi-finger events to be triggered.

Regarding virtual multiselecting applications, the spatial mouse can enable selection of multiple objects in a scene or multiple parts of a scene. For example, the user may click on peanut butter and a slice of bread and ask an AI what meals a user can make using the two ingredients. If the multiple selections are in a single camera frame, the user could simply pass multiple cursor locations to the AI system. When the multiple selections are distributed across multiple locations that can only be captured by several frames, for example, the user may retain the camera frames (or their subsets, e.g., via cropping) associated with the multiple selections.

These retained captures can be consolidated before they are fed to the AI system. The user may drag to create a 3D or 2D box for selecting a particular region with a hand gesture to indicate the two opposite corners for the selection box.

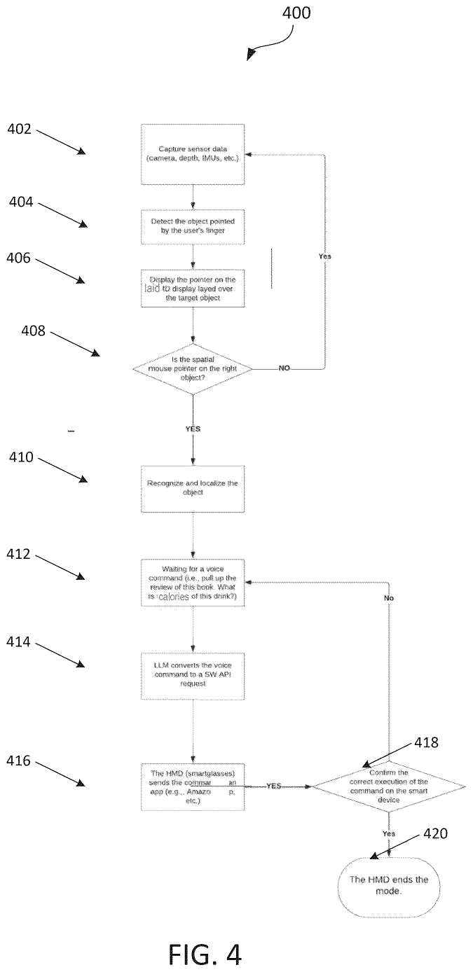

FIG. 4 is a flow diagram illustrating an example of a method 400 of object interaction using a spatial mouse, according to some aspects of the subject technology. The method 400 includes steps 402 through 420, as discussed herein.

In step 402, data from sensors such as a camera, a microphone, an inertial measurement unit (IMU), a depth sensor and the like are captured. In some implementations, the sensors can be integrated with the HMD (e.g., HMD 100 of FIG. 1).

In step 404, the object (e.g., 220 of FIG. 2) pointed by the user's finger is detected, for example, by a processor (e.g., 114 of FIG. 1) of the HMD.

In step 406, the HMD display shows a pointer laid over the target object (e.g., 220).

In step 408, the processor checks whether the spatial mouse pointer is on the right object. If it is determined that the spatial mouse pointer is not on the right object, the control is passed to step 402. However, if it is determined that the spatial mouse pointer is on the right object, the control is passed to step 410.

In step 410, the object is recognized by the processor and localized in the 3D space.

The object may be, for example, a book or a drink.

In step 412, a voice command is received from the user. The voice command may ask to pull up a review of the book or the calories of the drink.

In step 414, a large language model (LLM) and/or a vision language model (VLM) convert the voice command to a software (SW) application programming interface (API) request.

In step 416, the HMD (e.g., HMD 100 of FIG. 1), for example, MR devices or smart glasses, sends a command to an app (e.g., Amazon, Yelp and the like).

In step 418, it is checked to confirm that the voice command is correctly executed. If it is determined that the voice command is not executed correctly, the control is passed to step 412. Otherwise, if it is determined that the voice command is executed correctly, at the next step 420, the processor of the HMD ends the operation.

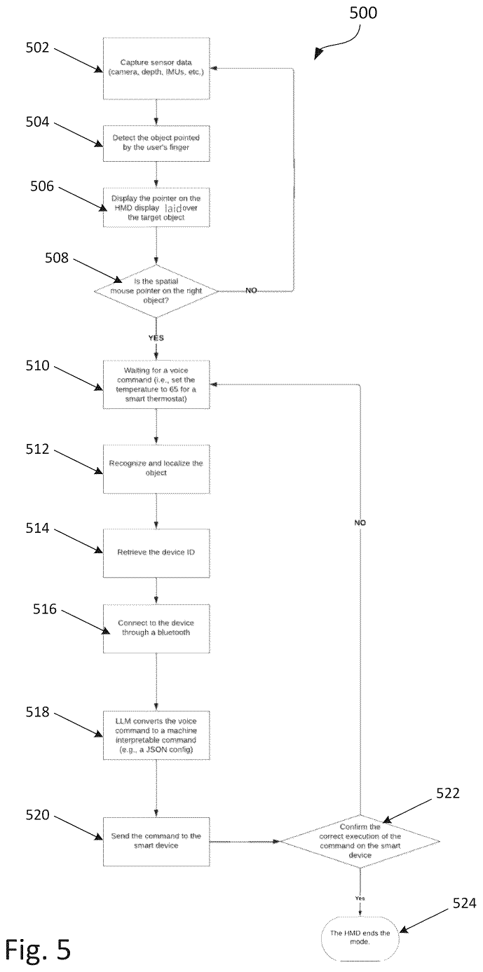

FIG. 5 is a flow diagram illustrating an example of a method 500 of a smart home integration using a spatial mouse, according to some aspects of the subject technology. The method 500 includes steps 502 through 524, as discussed herein.

In step 502, data from sensors such as a camera, a microphone, an IMU, a depth sensor and the like are captured. In some implementations, the sensors can be integrated with the HMD (e.g., HMD 100 of FIG. 1).

In step 504, the object (e.g., 220 of FIG. 2) pointed by the user's finger is detected, for example, by a processor (e.g., 114 of FIG. 1) of the HMD.

In step 506, the HMD display shows a pointer laid over the target object (e.g., 220).

In step 508, the processor checks whether the spatial mouse pointer is on the right object. If it is determined that the spatial mouse pointer is not on the right object, the control is passed to step 502. Otherwise, if it is determined that the spatial mouse pointer is on the right object, the control is passed to step 510. In some implementations, the right object can be a smart thermostat of the smart home.

In step 510, a voice command is received from the user. The voice command may ask to set the temperature of the smart thermostat, for example, to 65 degrees.

In step 512, the object (e.g., the smart thermostat) is recognized by the processor and localized in the 3D space.

In step 514, the device ID corresponding to the recognized object is retrieved from the memory (e.g., 116 of FIG. 1).

In step 516, a connection via Bluetooth is established with the device (e.g., the smart thermostat).

In step 518, the LLM and/or VLM convert the voice command to a machine interpretable command, for example, a JavaScript object notation (JSON) config command.

In step 520, the machine interpretable command is sent to the smart device (e.g., the smart thermostat).

In step 522, it is checked to confirm that the voice command is correctly executed on the smart device. If it is determined that the voice command is not executed correctly, the control is passed to step 510. Otherwise, if it is determined that the voice command is executed correctly, at the next step 524, the processor of the HMD ends the operation.

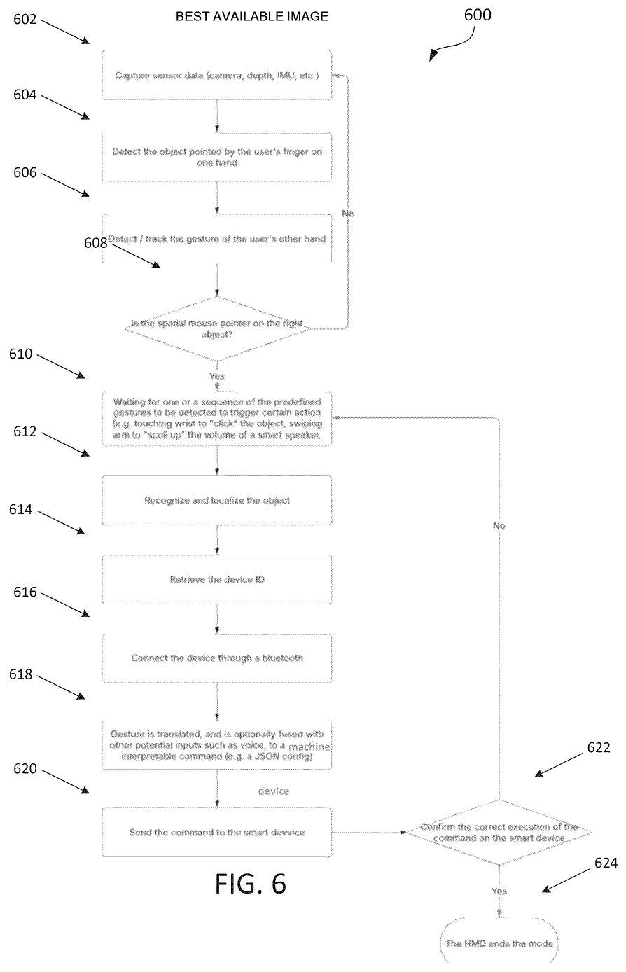

FIG. 6 is a flow diagram illustrating an example of a method 600 of a hand gesture for various actions, according to some aspects of the subject technology. The method 600 includes steps 602 through 624, as discussed herein.

In step 602, data from sensors such as a camera, a microphone, an IMU, a depth sensor and the like are captured. In some implementations, the sensors can be integrated with the HMD (e.g., HMD 100 of FIG. 1).

In step 604, the object (e.g., 220 of FIG. 2) pointed by the user's finger is detected, for example, by a processor (e.g., 114 of FIG. 1) of the HMD.

In step 606, the gestures of the user's other hand (e.g., 206 of FIG. 3) are tracked and/or detected by the sensors and the processor (e.g., 114 of FIG. 1).

In step 608, it is checked whether the spatial mouse pointer is on the right object.

In step 610, triggering certain actions (e.g., click an object or scroll up the volume of a speaker) is done after one or a sequence of gestures (e.g., touching wrist to click the object or swiping arm to scroll up the volume of a smart speaker) are detected.

In step 612, the object pointed to by the user's hand (e.g., 204 of FIG. 2) is recognized and localized by the processor.

In step 614, a device ID associated with the object (e.g., the speaker) is retrieved.

In step 616, connection to the device (e.g., a smart device such as the speaker) is established.

In step 618, the gesture is translated and is optionally fused with other potential inputs, such as voice, to a machine language interpretable command (e.g., JSON config).

In step 620, the command is sent to the smart device.

In step 622, it is confirmed whether the command was correctly executed on the smart device. If the command was not correctly executed on the smart device, the control is passed to step 610. Otherwise, if the command was correctly executed on the smart device, in step 624, the HMD ends the operation.

An aspect of the subject technology is directed to an apparatus including an apparatus including a number of sensors to detect one or more objects pointed to by a spatial mouse. The system further includes a processor to process data from the plurality of sensors, recognize the objects based on the processed data and execute a command based on the recognized objects.

In some implementations, the one or more objects comprise smart devices in a smart home.

In one or more implementations, the smart devices comprise switches, thermostats, speakers, lights, heaters, coolers, air conditioners and humidifiers.

In some implementations, the plurality of sensors comprise a camera, a microphone, an inertial measurement unit (IMU) and a depth sensor.

In one or more implementations, the spatial mouse is represented by a finger of a first hand of a user that points to the one or more objects.

In some implementations, the plurality of sensors are configured to detect a gesture by a second hand of a user.

In one or more implementations, the processor is configured to recognize the gesture by the second hand of the user.

In some implementations, the processor is configured to execute the command based on the recognized gesture by the second hand of the user.

In one or more implementations, the processor is configured to execute the command to cause actions on the one or more objects.

In some implementations, the actions comprise object selection, turning on, turning off, turning up, turning down, clicking, scrolling up, and scrolling down.

Another aspect of the subject technology is directed to method that includes detecting a target object pointed to by a user based on data captured by a number of sensors, and displaying a pointer laid over the detected target object on a display of a head-mount device (HMD) to confirm, by the user, that a spatial mouse pointer is on a right object. The method further includes recognizing and localizing the target object, and sending a command based on the detected recognized and localized target object.

In some implementations, detecting the target object is based on the data captured by the plurality of sensors comprising a camera, a microphone, an IMU and a depth sensor.

In one or more implementations, the method further comprises receiving a voice command from the user.

In some implementations, the method further comprises using an LLM and or a VLM convert the voice command to a software (SW) application programming interface (API) request or a machine interpretable command.

In one or more implementations, the target object comprises a smart device and the method further comprises retrieving a device identification (ID) associated with the smart device and connecting to the smart device using a Bluetooth (BT) protocol.

In some implementations, sending the command includes sending the SW API request to one of an application including a commercial application; or sending the machine interpretable command to the smart device.

In one or more implementations, the method further comprises confirming a correct execution of the command.

Yet another aspect of the subject technology is directed to a method including receiving sensor data from several sensors, and detecting and recognizing an object pointed to by a spatial mouse represented by a first hand of a user based on the sensor data. The method further includes recognizing one or more gestures by a second hand of the user based on the sensor data and the detected object, and sending a command based on the detected, recognized object and the recognized one or more gestures.

In one or more implementations, the object comprises a smart device and the method further comprises retrieving a device ID associated with the smart device; and connecting to the smart device using a BT protocol.

In some implementations, the method further includes translating the one or more gestures to a machine interpretable command using an LLM and or a VLM; fusing the translated one or more gestures with other potential inputs including one or more voice commands; and sending the machine interpretable command to the smart device for execution by the smart device.

In some implementations, the word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

Aspects of the subject matter described in this disclosure can be implemented to realize one or more of the following potential advantages. The described techniques may be implemented to support a range of benefits and significant advantages of the disclosed eye tracking (ET) system. It should be noted that the subject technology enables fabrication of a depth-sensing apparatus that is a fully solid-state device with small size, low power, and low cost.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. An apparatus, comprising:
a plurality of sensors configured to detect at least one object identified based on an indication by a spatial mouse, the at least one object being external to the spatial mouse; and
a processor configured to:
process data from the plurality of sensors;
recognize at least one object based on the data that is processed; and
render, responsive to the recognition of the at least one object, a visual indicator extending from the spatial mouse to an intersection point on the at least one object;
highlight a part of the at least one object associated with the intersection point, the highlighting comprising:
segmenting the part of the at least one object relative to a rest of the at least one object, and
modifying at least one cue specific to the part as compared to the rest of the at least one object; and
execute a command based on the at least one object that is recognized.

2. The apparatus of claim 1, wherein the one or more objects comprise smart devices in a smart home.

3. The apparatus of claim 2, wherein the smart devices comprise switches, thermostats, speakers, lights, heaters, coolers, air conditioners and humidifiers.

4. The apparatus of claim 1, wherein the plurality of sensors comprise a camera, a microphone, an inertial measurement unit (IMU) and a depth sensor.

5. The apparatus of claim 1, wherein the spatial mouse is represented by a finger of a first hand of a user that points to the one or more objects.

6. The apparatus of claim 1, wherein the plurality of sensors are configured to detect a gesture by a second hand of a user.

7. The apparatus of claim 6, wherein the processor is configured to recognize the gesture by the second hand of the user.

8. The apparatus of claim 7, wherein the processor is configured to execute the command based on the recognized gesture by the second hand of the user.

9. The apparatus of claim 1, wherein the processor is configured to execute the command to cause actions on the one or more objects.

10. The apparatus of claim 9, wherein the actions comprise object selection, turning on, turning off, turning up, turning down, clicking, scrolling up, and scrolling down.

11. A method, comprising:
detecting at least one target object pointed to by a user based on data captured by a plurality of sensors;
displaying a pointer laid over the at least one target object on a display of a head-mount device (HMD);
recognizing the at least one target object and localizing the target object;
rendering, responsive to the recognition of the at least one target object, a visual indicator extending from the spatial mouse to an intersection point on the at least one object;
highlighting a part of the at least one object associated with the intersection point, the highlighting comprising:
segmenting the part of the at least one object relative to a rest of the at least one object, and
modifying at least one cue specific to the part as compared to the rest of the at least one object; and
sending a command.

12. The method of claim 11, wherein detecting the target object is based on the data captured by the plurality of sensors comprising a camera, a microphone, an IMU and a depth sensor.

13. The method of claim 11, further comprising receiving a voice command from the user.

14. The method of claim 13, further comprising using at least one of a large language model (LLM) or a vision language model (VLM) to convert the voice command to a software (SW) application programming interface (API) request or a machine interpretable command.

15. The method of claim 14, wherein the target object comprises a smart device and the method further comprises retrieving a device identification (ID) associated with the smart device and connecting to the smart device using a Bluetooth (BT) protocol.

16. The method of claim 15, wherein sending the command comprises:
sending the SW API request to one of an application including a commercial application; or
sending the machine interpretable command to the smart device.

17. The method of claim 11, further comprising confirming a correct execution of the command.

18. A method, comprising:
receiving sensor data from a plurality of sensors;
detecting and recognizing at least one object pointed to by a spatial mouse represented by a first hand of a user based on the sensor data;
recognizing the at least one target object based on one or more gestures by a second hand of the user based on the sensor data and the target object that is detected; and
rendering, responsive to the recognition of the at least one target object, a visual indicator extending from the spatial mouse to an intersection point on the at least one target object;
highlighting a part of the at least one object associated with the intersection point, the highlighting comprising:
segmenting the part of the at least one object relative to a rest of the at least one object, and
modifying at least one cue specific to the part as compared to the rest of the at least one object; and
sending a command based on the detected, recognized object and the recognized one or more gestures.

19. The method of claim 18, wherein the object comprises a smart device and the method further comprises:
retrieving a device ID associated with the smart device; and
connecting to the smart device using a BT protocol.

20. The method of claim 19, further comprising:
translating the one or more gestures to a machine interpretable command using at least one or an LLM or a VLM;
fusing the translated one or more gestures with other potential inputs including one or more voice commands; and
sending the machine interpretable command to the smart device for execution by the smart device.
